(19) United States
(12) Patent Application Publication
(10) Pub. No.: US 2024/0387790 A1
(43) Pub. Date: Nov. 21, 2024

(54) REMNANT COLLECTION APPARATUS

(71) Applicant: Prime Planet Energy & Solutions, Inc., Tokyo (JP)

(72) Inventor: Masanori SUZUKI, Takatsuki-shi (JP)

(21) Appl. No.: 18/663,072

(22) Filed: May 14, 2024

(30) Foreign Application Priority Data
May 19, 2023 (JP) 2023-082851

(51) Int. Cl. H01M 4/04; B23K 26/38; B65H 16/00; B65H 20/02

(52) U.S. Cl. CPC H01M 4/04; B23K 26/38; B65H 16/00; B65H 20/02; B65H 2801/72

(57) ABSTRACT

A remnant collection apparatus for an electricity storage device includes an absorption device absorbing a remnant generated when a band-like electrode material is cut along a longitudinal direction thereof to form an electrode sheet; and a guide provided on a transportation route of the remnant transported by the absorption performed by the absorption device. The guide includes a gap extending in a width direction of the remnant, the remnant being insertable through the gap.

### CROSS REFERENCE TO RELATED APPLICATION

This application claims the benefit of priority to Japanese Patent Application No. 2023-082851 filed on May 19, 2023. The entire contents of this application are hereby incorporated by reference herein.

### BACKGROUND

The present invention relates to a remnant collection apparatus collecting a remnant generated during production of an electricity storage device.

For example, Japanese Laid-Open Patent Publication No. 2015-056255 discloses an apparatus that cuts off a portion to be used from a band-like sheet of a membrane electrode assembly usable for a fuel cell and also collects a ladder-like remnant that is left after the portion to be used is cut off. The apparatus described in Japanese Laid-Open Patent Publication No. 2015-056255 includes a pair of, more specifically, top and bottom, rollers that are rotatable while sandwiching the remnant. The top roller includes a groove that separates a surface of the roller into a roller surface area pressing one end portion of the remnant and another roller surface area pressing the other end portion of the remnant. According to the Japanese Laid-Open Patent Publication No. 2015-056255, the roller surface areas at both of two ends of the top roller rotate integrally with each other and subordinately to the rotation of the bottom roller, and transport the two end portions of the remnant by the same feed amount. Japanese Laid-Open Patent Publication No. 2015-056255 describes that for this reason, a situation where the remnant is split by a tensile force caused by the difference in the feed amount between the two end portions may be suppressed.

### SUMMARY

For producing an electrode sheet of an electricity storage device, a band-like electrode material may be cut in a longitudinal direction thereof to form the electrode sheet. In this case also, a remnant is generated. FIG. 4 is a side view schematically showing an example of remnant collection apparatus 110 collecting a remnant 3 generated when a band-like electrode material 1 is cut along a longitudinal direction thereof to form an electrode sheet 2. In FIG. 4, a point P2 is a separation point at which the electrode sheet 2 and the remnant 3 are separated from each other. As shown in FIG. 4, in such a conventional example, the remnant collection apparatus 110 includes a pair of nip rollers 121 and 122 rotatable while sandwiching the remnant 3. One of the nip rollers, i.e., the nip roller 122 is connected with a motor 123. The remnant 3 is sandwiched by the nip roller 122 rotated by being driven by the motor 123 and the other nip roller 121 rotating subordinately, and thus is transported along a route different from that of the electrode sheet 2 and is collected.

The transportation speed of the remnant 3 transported by the nip rollers 121 and 122 and the transportation speed of the electrode sheet 2 are matched to each other. However, it is difficult to perfectly match the transportation speed of the remnant 3 and the transportation speed of the electrode sheet 2 to each other. Therefore, there is an undesirable possibility that a tensile force is applied to the remnant 3 due to the difference between the transportation speed of the remnant 3 and the transportation speed of the electrode sheet 2, and as a result, the remnant 3 is severed at a position upstream with respect to the nip rollers 121 and 122. When being severed, the remnant 3 is not collected and thus the production of the electrode sheet 2 is stopped.

Thus, this application provides a remnant collection apparatus collecting a remnant generated when a band-like electrode material is cut along a longitudinal direction thereof to form an electrode sheet, such that the remnant is not severed easily.

A remnant collection apparatus for an electricity storage device disclosed herein includes an absorption device absorbing a remnant generated when a band-like electrode material is cut along a longitudinal direction thereof to form an electrode sheet; and a guide provided on a transportation route of the remnant transported by the absorption performed by the absorption device. The guide includes a gap extending in a width direction of the remnant, the remnant being insertable through the gap.

According to the above-described remnant collection apparatus, the remnant is absorbed by the absorption device, and thus is freely movable in a transportation direction thereof. Therefore, such a tensile force as to split the remnant is not easily applied to the remnant. In addition, the remnant is inserted through the gap, of the guide, which extends in the width direction of the remnant. Therefore, twisting of the remnant is suppressed by the transportation realized by the absorption. For this reason, such a torsional stress as to split the remnant is not easily applied to the remnant. In this manner, the above-described remnant collection apparatus may suppress the split of the remnant.

### BRIEF DESCRIPTION OF THE DRAWINGS

FIG. 1 is a perspective view of a remnant collection apparatus.

FIG. 2 is a side view schematically showing a structure of the remnant collection apparatus.

FIG. 3 is a front view of an electrode sheet and a remnant.

FIG. 4 is a side view schematically showing a structure of a nip roller-type remnant collection apparatus.

### DETAILED DESCRIPTION

Hereinafter, a preferred embodiment of a remnant collection apparatus for an electricity storage device will be described. The preferred embodiment described herein is not intended to specifically limit the present invention, needless to say. The drawings show schematic views, and do not reflect any actual product embodying the present invention.

### [Structure of the Remnant Collection Apparatus]

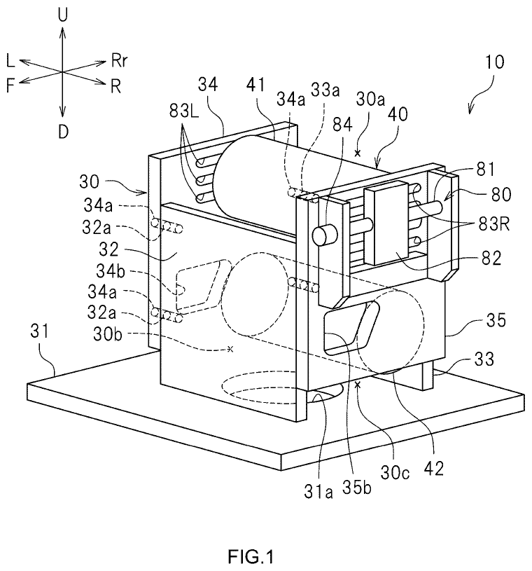

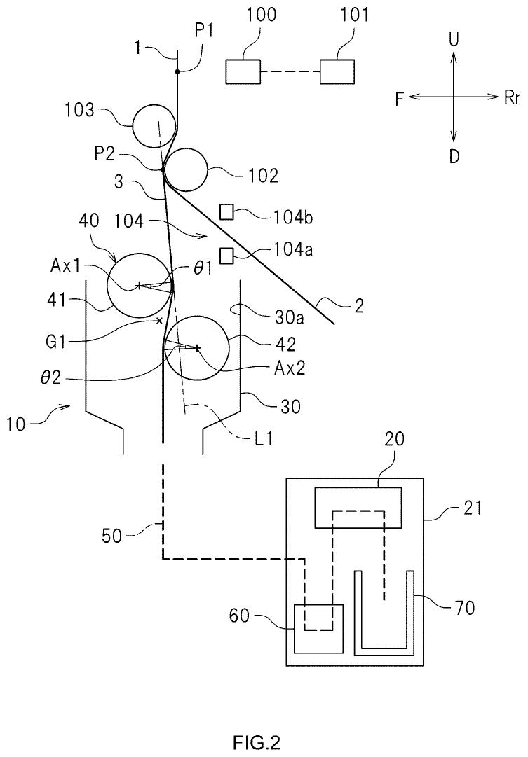

FIG. 1 is a perspective view of a remnant collection apparatus 10 according to a preferred embodiment. FIG. 2 is a side view schematically showing a structure of the remnant collection apparatus 10. The remnant collection apparatus 10 is a device that collects a remnant 3 generated when a band-like electrode material 1 is cut along a longitudinal direction thereof to form an electrode sheet 2. The depth direction of the sheet of FIG. 2 is a width direction of the electrode material 1, the electrode sheet 2 and the remnant 3. The electrode material 1 is a band-like sheet, the width direction of which is the depth direction of the sheet of FIG. 2.

In FIG. 1 and FIG. 2, letter U represents upward, and letter D represents downward. The upward direction and the downward direction in the sheets of FIG. 1 and FIG. 2 are respectively an upward direction and a downward direction for the remnant collection apparatus 10. Hereinafter, the depth direction of the sheet of FIG. 2 (the width direction of the electrode material 1, the electrode sheet 2 and the remnant 3) will be referred to also as a “left-right direction”, and the left-right direction of the sheet of FIG. 2 will be referred to also as a “front-rear direction”. In the drawings referred to below, letters F, Rr, L and R respectively represent forward, rearward, leftward and rightward. These directions are merely for the convenience of the description, and do not limit the manner of installation of the remnant collection apparatus 10 in any way.

The electrode sheet 2 is an electrode sheet of an electricity storage device. Herein, the “electricity storage device” is a term representing, in general, a device capable of extracting electrical energy, and encompasses so-called storage batteries (chemical batteries) such as lithium ion secondary batteries, nickel hydrogen batteries and the like, and also capacitors (physical batteries) such as electric double layer capacitors and the like. The electrode sheet 2 is, for example, an electrode sheet of a lithium ion secondary battery. It should be noted that the electrode sheet 2 is not limited to the electrode sheet of a lithium ion secondary battery, and may be an electrode sheet of any of various other known electricity storage devices.

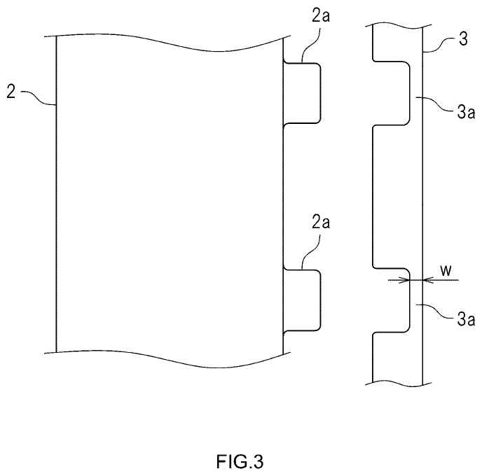

As shown in FIG. 2, the electrode material 1 is cut at a cutting point P1 while being transported in the longitudinal direction thereof. At the cutting point P1, the electrode material 1 is transported downward. In this embodiment, the electrode material 1 is cut by a laser cutter 100. In this preferred embodiment, the laser cutter 100 is moved in the width direction of the electrode material 1 (in this embodiment, in the left-right direction) by a moving device 101. As a result, the electrode material 1 is cut in a zigzag manner. FIG. 3 is a front view of the electrode sheet 2 and the remnant 3. In FIG. 3, the electrode sheet 2 and the remnant 3 are shown as being separate from each other in the width direction. As shown in FIG. 3, the electrode material 1 (see FIG. 2) is cut in a zigzag manner, so that a plurality of tabs 2a aligned in the longitudinal direction of the electrode sheet 2 are formed in the electrode sheet 2. The plurality of tabs 2a each protrude in the width direction of the electrode sheet 2 beyond a remaining portion of the electrode sheet 2. The remnant 3 is generated during the formation of the tabs 2a. The remnant 3 includes narrow portions 3a, which correspond to the tabs 2a and have a smaller width than that of the remaining portion of the remnant 3. It should be noted that the remnant 3 is not limited to being generated during the formation of the tabs 2a. The remnant 3 does not need to include the narrow portions 3a. The electrode material 1 is not limited to being cut by the laser cutter.

As shown in FIG. 2, the electrode sheet 2, after being formed, is wound along a guide roll 102, and as a result, the transportation direction of the electrode sheet 2 is changed. A transportation device (not shown) transporting the electrode sheet 2 provided downstream, in the transportation direction of the electrode sheet 2, with respect to the guide roll 102. The electrode sheet 2 is wound along the guide roll 102 and is also pulled by the transportation device, and as a result, is transported in a direction different from the downward direction, in which the electrode sheet 2 is transported until reaching the guide roll 102. The remnant 3 advances downward by the action of the gravity, and is collected by the remnant collection apparatus 10 provided below the guide roll 102. In FIG. 2, a point P2 is a separation point at which the remnant 3 is separated from the electrode sheet 2. In this embodiment, the separation point P2 is on the guide roll 102.

A reference roll 103 is provided at a position that is upstream, in the transportation direction of the electrode sheet 2, with respect to the guide roll 102 and faces the guide roll 102 across a transportation route of the electrode sheet 2. The electrode sheet 2 is in contact with the reference roll 103 at a position upstream with respect to the position at which the reference sheet 2 is wound along the guide roll 102. The position of the electrode sheet 2 at the cutting point P1 in the front-rear direction is defined by the reference roll 103.

As shown in FIG. 2, the transportation device for the electrode sheet 2 includes a sensor 104 sensing the tabs 2a. The sensor 104 is, for example, an optical sensor. Each of the tabs 2a crosses an optical axis of light emitted by a light emitter 104a of the sensor 104 toward a light receiver 104b of the sensor 104. The light emitted by the light emitter 104a is blocked by the tab 2, so that the sensor 104 detects the tab 2a. In the case where the tabs 2a are continued to be detected for a predetermined time length or longer, the transportation device determines that the remnant 3 is not collected by the remnant collection apparatus 10 but is transported with the electrode sheet 2, and stops the transportation of the electrode sheet 2. The transportation device includes a tensile force detection sensor (not shown) detecting a tensile force of the electrode sheet 2. In the case where the tensile force of the electrode sheet 2 is decreased to a level below a predetermined level, the transportation device determines that the electrode sheet 2 has been split and stops the transportation of the electrode sheet 2.

As shown in FIG. 2, the remnant collection apparatus 10 includes an absorption device 20 absorbing the remnant 3, a tubular cover 30 connected with the absorption device 20, a remnant guide 40 accommodated in the cover 30, a duct 50, a pulverization device 60 for the remnant 3, and a collection box 70 for the pulverized waste. In this preferred embodiment, the pulverization device 60, the absorption device 20 and the collection box 70 are accommodated in one casing 21, and are located in this order on the transportation route of the remnant 3 from the upstream side. The casing 21 is located away from the cover 30. The duct 50 connects a bottom portion of the cover 30 and the casing 21 to each other. The cover 30 is connected with the absorption device 20 via the duct 50 and a pipe in the casing 21.

As shown in FIG. 1, the cover 30 includes a bottom plate 31 acting as a bottom portion, a front plate 32, a rear plate 33, a left side plate 34 and a right side plate 35. The bottom plate 31 includes a duct hole 31a formed therein, which is connected with the duct 50. The front plate 32 and the rear plate 33 are each connected with a top surface of the bottom plate 31, and respectively act as a front surface and a rear surface of the cover 30. The front plate 32 and the rear plate 33 face each other across the remnant guide 40. The left side plate 34 is connected with a left end of the front plate 32 and a left end of the rear plate 33, and acts as a left side surface of the cover 30. The right side plate 35 is connected with a right end of the front plate 32 and a right end of the rear plate 33, and acts as a right side surface of the cover 30. The left side plate 34 and the right side plate 35 face each other across the remnant guide 40. A top surface of the cover 30 is opened, and acts as a suction opening 30a. The remnant 3 is inserted into the cover 30 through the suction opening 30a. The remnant 3 is absorbed, together with the air, through the suction opening 30a.

The left side plate 34 is secured to the front plate 32 and the rear plate 33 such that the position of the left side plate 34 in an up-down direction is changeable. The left side plate 34 includes a plurality of through-holes 34a, through each of which a bolt (not shown) is insertable. A left side surface of the front plate 32 includes a plurality of screw holes 32a aligned in the up-down direction. A left side surface of the rear plate 33 includes a plurality of screw holes 33a aligned in the up-down direction. Bolts are respectively inserted into the plurality of through-holes 34a of the left side plate 34 and are tightened to a selected screw hole among the plurality of screw holes 32a and a selected screw hole among the plurality of screw holes 33a. In this manner, the position of the left side plate 34 in the up-down direction may be selected. The position of the left side plate 34 in the up-down direction is changed, so that the height of a gap 30b between a bottom end of the left side plate 34 and the bottom plate 31 may be changed. Along with the absorption performed by the absorption device 20, air in an amount corresponding to the height of the gap 30b flows into the cover 30 through the gap 30b. The gap 30b is an opening, the height of which is adjustable to adjust a suction force. The gap 30b is also an observation window that allows the inside of the cover 30 to be visually recognized and to be accessed.

As shown in FIG. 1, the left side plate 34 includes an observation window 34b formed therein. The observation window 34b allows the remnant guide 40 to be visually recognized. The observation window 34b allows the inside of the cover 30, especially, the remnant guide 40 and the vicinity thereof, to be visually recognized and to be accessed. In this embodiment, the observation window 34b is an opening allowing an operation worker to access the inside of the cover 30. Along with the absorption performed by the absorption device 20, air flows into the cover 30 also through the observation window 34b. The observation window 34b is also an opening usable to adjust the suction force to absorb the remnant 3.

The right side plate 35 also includes an observation window 35b formed therein, and a gap 30c is formed between a bottom end of the right side plate 35 and the bottom plate 31. The position of the right side plate 35 in the up-down direction is changed, so that the height of the gap 30c may be changed. The gap 30c below the right side plate 35 and the observation window 35b in the right side plate 35 respectively have substantially the same functions as those of the gap 30b below the left side plate 34 and the observation window 34b in the left side plate 34.

As described above, the left side plate 34 and the right side plate 35 facing each other across the remnant guide 40 include the openings (in this embodiment, the gaps 30b and 30c below the left side plate 34 and the right side plate 35, and the observation windows 34b and 35b in the left side plate 34 and the right side plate 35; hereinafter, the gap 30b and the observation window 34b may be collectively referred to as the “openings of the left side plate 34”, and the gap 30c and the observation window 35b may be collectively referred to as the “openings of the right side plate 35”). Through the openings of the left side plate 34 and the openings of the right side plate 35, the air outside the cover 30 flows into the cover 30. The air flowing into the cover 30 through the openings of the left side plate 34 and the air flowing into the cover 30 through the openings of the right side plate 35 act to hold the remnant 3 at the center in the cover 30.

The remnant guide 40 is provided on the transportation route of the remnant 3 transported by the absorption performed by the absorption device 20. The remnant guide 40 is an element that guides the absorbed remnant 3 such that the remnant 3 is not twisted. As shown in FIG. 2, the remnant guide 40 includes a gap G1, which extends in the width direction of the remnant 3 (in this embodiment, in the left-right direction) and through which the remnant 3 passes. The remnant 3 is caused to pass through the gap G1 extending in the width direction of the remnant 3, and therefore, is restricted in the movement thereof and is prevented from being twisted.

In this preferred embodiment, the remnant guide 40 includes a pair of rollers 41 and 42 forming the gap G1. The pair of rollers 41 and 42 each have a cylindrical shape extending in the width direction of the remnant 3. The pair of rollers 41 and 42 are respectively rotatable about axes Ax1 and Ax2 extending in the width direction of the remnant 3.

The pair of rollers 41 and 42 include a first roller 41 provided on the upstream side and a second rollers 42 located downstream, in the transportation route of the remnant 3, with respect to the first roller 41. In this embodiment, the first roller 41 is located to the front of the second roller 42. The second roller 42 is located so as to overlap tangent L1 drawn so as to pass a point on an outer circumferential surface of the first roller 41 from the separation point P2, at which the remnant 3 is separated from the electrode sheet 2. The second roller 42 extends to a position to the front of the tangent L1. The first roller 41 and the second roller 42 are located so as to partially overlap each other in the front-rear direction. The positional relationship between the first roller 41 and the second roller 42 in the front-rear direction may be opposite to that shown in FIG. 2.

As shown in FIG. 2, the remnant 3, in a state of being inserted into the gap G1, drops so as to be along the tangent L1 from the separation point P2, and then is wound along a rear surface of the first roller 41 and reaches a front surface of the second roller 42. Then, the remnant 3 is wound along the front surface of the second roller 42 and advances downward. As shown in FIG. 2, the second roller 42, together with the first roller 41, bends the transportation route of the remnant 3 into an S shape. The first roller 41 and the second roller 42 do not sandwich the remnant 3, but, as shown in FIG. 2, define the transportation route of the remnant 3 and thus restrict the movement of the remnant 3.

As shown in FIG. 1, the remnant collection apparatus 10 includes an adjustment device 80 capable of causing the first roller 41 and the second roller 42 to be closer to, or to be farther from, each other. The adjustment device 80 is provided on a top portion of the right side plate 35. In this embodiment, the adjustment device 80 moves the first roller 41 in the front-rear direction such that the first roller 41 and the second roller 42 are made closer to, or farther from, each other.

In this embodiment, the adjustment device 80 includes a ball screw 81 extending in the front-rear direction, a movable body 82 engaged with the ball screw 81 and supporting the first roller 41, a plurality of right guide grooves 83R extending in the front-rear direction and engaged with the movable body 82 such that the movable body 82 is slidable, and a plurality of left guide grooves 83L extending in the front-rear direction and engaged with a left end of the rotation axis of the first roller 41 such that the left end is slidable. The left guide grooves 83L are formed in the left side plate 34. The plurality of left guide grooves 83L are aligned in the up-down direction. A knob 84 is provided at a front end of the ball screw 81. The knob 84 is grasped by an operation worker performing the work of adjustment to rotate the ball screw 81. The operation worker performing the work of adjustment may rotate the ball screw 81 to adjust the distance between the first roller 41 and the second roller 42. In this manner, the width of the gap G1, the wrap angle θ1 (see FIG. 2) of the first roller 41, and the wrap angle θ2 (see FIG. 2) of the second roller 42 may be adjusted. The wrap angle θ1 and the wrap angle θ2 are adjusted, so that the tensile force applied to the remnant 3 may be adjusted. As shown in FIG. 1, the second roller 42 is rotatably supported by the left side plate 34 and the right side plate 35, and the position thereof in the front-rear direction is fixed.

### [Procedure of Use of the Remnant Collection Apparatus]

Hereinafter, a procedure of use of the remnant collection apparatus 10 will be described. The remnant collection apparatus 10 collects the remnant 3 as follows. The electrode material 1 is cut in the longitudinal direction thereof to form a short piece of the remnant 3, and a tip of the remnant 3 is inserted through the gap G1 between the first roller 41 and the second roller 42. When the absorption device 20 is driven, the tip of the remnant 3 is absorbed downward through the gap G1. In the case where the absorption device 20 is already driven before the remnant 3 is inserted through the gap G1, the tip of the remnant 3 is spontaneously absorbed into the gap G1 when being put close to the first roller 41. Before the remnant collection apparatus 10 is used, the positions of the left side plate 34 and the right side plate 35 in the up-down direction are adjusted, such that the suction force is appropriate. In addition, the adjustment device 80 is adjusted such that the wrap angle θ1 of the first roller 41 and the wrap angle θ2 of the second roller 42 are appropriate. In this manner, the tensile force to be applied to the remnant 3 is adjusted to be appropriate such that the remnant 3 is not flapped when being absorbed or split and such that the electrode material 1 does not sag at the cutting point P1.

The remnant 3 inserted through the gap G1 is transported to the pulverization device 60 after passing through an area in the cover 30 below the second roller 42 and passing through the duct 50. The remnant 3 is pulverized by the pulverization device 60. The pulverized waste of the remnant 3 is put into the collection box 70 after passing through the absorption device 20.

If the remnant 3 is split upstream with respect to the remnant guide 40 and transported together with the electrode sheet 2, the sensor 104 of the transportation device for the electrode sheet 2 senses this. In this case, the transportation of the electrode sheet 2 is stopped. The possibility that the remnant 3 is split downstream with respect to the remnant guide 40 is relatively high. In this case, the end of the split piece of the remnant 3 continues to be pulled by the absorption device 20, and therefore, no problem occurs for the transportation of the electrode sheet 2. If the electrode sheet 2 is split from the position of the split in the remnant 3, the tensile force detection sensor of the transportation device senses this. In this case also, the transportation of the electrode sheet 2 is stopped. In the case where the transportation of the electrode sheet 2 is stopped, the state of the electrode sheet 2 is returned to the normal state, and then, the tip of the remnant 3 is inserted again through the gap G1 between the first roller 41 and the second roller 42.

### [Functions and Effects of the Remnant Collection Apparatus]

Hereinafter, the functions and the effects provided by the remnant collection apparatus 10 will be described.

The remnant collection apparatus 10 according to this preferred embodiment includes the absorption device 20 absorbing the remnant 3 generated when the band-like electrode material 1 is cut along the longitudinal direction thereof to form the electrode sheet 2, and the remnant guide 40 provided on the transportation route of the remnant 3 transported by the absorption performed by the absorption device 20. The remnant guide 40 includes the gap G1, which extends in the width direction of the remnant 3 and through which the remnant 3 is insertable. With the remnant collection apparatus 10 having such a structure, the remnant 3 is absorbed by the absorption device 20, and thus is freely movable in the transportation direction. Therefore, such a tensile force as to split the remnant 3 is not easily applied to the remnant 3. In addition, the remnant 3 is inserted through the gap G1, of the remnant guide 40, which extends in the width direction of the remnant 3. Therefore, twisting of the remnant 3 is suppressed by the transportation realized by the absorption. For this reason, such a torsional stress as to split the remnant 3 is not easily applied to the remnant 3, and this may suppress the split of the remnant 3. If the gap G1 is not provided, the movement of the remnant 3 is not restricted. Therefore, the remnant 3 may be twisted in various manners upon receiving the suction force from the absorption device 20. The remnant 3 is inserted through the gap G1, so that such a twist may be suppressed.

Even if the electrode sheet 2 is split and the production of the electrode sheet 2 is stopped, the remnant 3 is absorbed into the remnant collection apparatus 10 when the end of the remnant 3 is put close to the remnant guide 40. In this manner, the operation of collecting the remnant 3 by the remnant collection apparatus 10 may be restored. Therefore, the operation of collecting the remnant 3 is restored more easily by the remnant collection apparatus 10 than by the conventional structure in which the remnant 3 is sandwiched between the nip rollers.

In this preferred embodiment, the remnant guide 40 includes the pair of first rollers 41 and 42, each of which has a cylindrical shape extending in the width direction of the remnant 3 and which form the gap G1. With such a structure, the pair of rollers 41 and 42 are cylindrical, and therefore, the remnant 3 may pass through the gap G1 smoothly. This further prevents the remnant 3 from being split. The pair of members each of which has a cylindrical shape extending in the width direction of the remnant 3 and which form the gap G1 may be cylindrical shafts that are not rotatable.

In this preferred embodiment, the pair of rollers 41 and 42 are respectively rotatable about the axes Ax1 and Ax2 extending in the width direction of the remnant 3. With such a structure, the pair rollers 41 and 42 are both rotated in the transportation direction of the remnant 3. Therefore, the remnant 3 may pass through the gap G1 more smoothly. This still further prevents the remnant 3 from being split.

In this preferred embodiment, the pair of rollers 41 and 42 include the first roller 41 and the second roller 42 located downstream, in the transportation route of the remnant 3, with respect to the first roller 41. The second roller 42 is located so as to overlap the tangent L1 drawn so as to pass a point on the outer circumferential surface of the first roller 41 from the separation point P2, at which the remnant 3 is separated from the electrode sheet 2. The second roller 42, together with the first roller 41, bends the transportation route of the remnant 3 into an S shape. With such a structure, a tensile force is applied to the remnant 3 between the first roller 41 and the second roller 42. This further prevents the remnant 3 from being twisted.

If the second roller 42 is located so as not to overlap the tangent L1, the remnant 3 is not wound along the first roller 41 and the second roller 42. Therefore, a tensile force generated by the remnant 3 being wound along the first roller 41 and the second roller 42 is not applied to the remnant 3. In this case, the restriction on the movement of the remnant 3 may be weakened depending on the size of the space between the first roller 41 and the second roller 42 (width of the gap G1). This increases the possibility that the remnant 3 is twisted. In the case where the second roller 42 is located so as to overlap the tangent L1, the remnant 3 is wound along the first roller 41 and the second roller 42. Therefore, a tensile force is applied to the remnant 3 regardless of the size of the space between the first roller 41 and the second roller 42 (width of the gap G1). This restricts the movement of the remnant 3. Therefore, the remnant 3 is not easily twisted. For example, in the case where the size of the space between the first roller 41 and the second roller 42 (width of the gap G1) is made larger, the work of inserting the remnant 3 through the gap G1 is made easier.

The remnant collection apparatus 10 according to this preferred embodiment includes the adjustment device 80 capable of causing the first roller 41 and the second roller 42 to be closer to, or to be farther from, each other. With such a structure, the first roller 41 and the second roller 42 are caused to be closer to, or to be farther from, each other, so that the tensile force to be applied to the remnant 3 between the first roller 41 and the second roller 42 may be adjusted.

The remnant collection apparatus 10 according to this preferred embodiment includes the tubular cover 30 connected with the absorption device 20 and accommodating the remnant guide 40. The cover 30 includes the observation windows 34b and 35b, through which the remnant guide 40 is visually recognizable. The provision of the cover 30 allows the suction force provided by the absorption device 20 to be effectively used. By contrast, the provision of the cover 30 makes it difficult to visually recognize the remnant guide 40. Therefore, in this preferred embodiment, the cover 30 includes the observation windows 34b and 35b. The provision of the observation windows 34b and 35b allows the remnant guide 40 enclosed by the cover 30 to be visually recognized easily. This makes it easy to visually recognize the state of the remnant guide 40 and the remnant 3.

In this preferred embodiment, the observation windows 34b and 35b are each an opening acting both to provide an access to the remnant guide 40 and to adjust the suction force. However, the observation windows 34b and 35b may be windows covered with transparent covers, for example.

In this preferred embodiment, the cover 30 includes the left side plate 34 and the right side plate 35 facing each other across the remnant guide 40. The left side plate 34 and the right side plate 35 respectively include the openings (in this embodiment, the openings 30b and 30c below the left side plate 34 and the right side plate 35, and the observation windows 34b and 35b). With such a structure, the air flowing into the cover 30 through the openings of the left side plate 34 and the air flowing into the cover 30 through the openings of the right side plate 35 push the remnant 3 against each other so as to hold the remnant 3 at the center in the cover 30. This easily allows the remnant 3 to be held at the center in the cover 30.

In this preferred embodiment, the remnant 3 includes the narrow portions 3a, which are narrower than the remaining portion thereof. The remnant 3 having such a structure causes a stress to be concentrated on the narrow portions 3a and thus is easily split at the narrow portions 3a. Therefore, the remnant collection apparatus 10 according to this preferred embodiment provides an effect especially for collecting the remnant 3 including the narrow portions 3a.

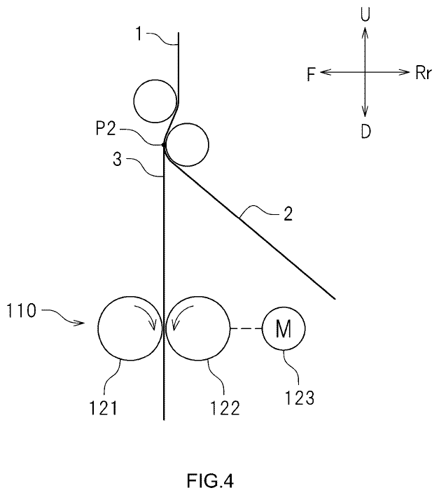

With a prototype of the remnant collection apparatus 10 according to this preferred embodiment produced by the present inventor, the remnant 3 including the narrow portions 3a each having a width W (see FIG. 3) of about 6 mm or greater was collected without being split at a position upstream with respect to the remnant guide 40. By contrast, with the conventional nip roll-type remnant collection apparatus as shown in FIG. 4, the remnant 3 including the narrow portions 3a each having a width W of about 10 mm or less was split and was not collected. The width W of the narrow portions 3a with which the remnant 3 is collectable may vary in accordance with the thickness or the material of the electrode material 1, however, as described above, there is a clear difference, regarding the minimum width with which the remnant 3 is collectable, between the remnant collection apparatus 10 according to this preferred embodiment and the conventional nip roll-type remnant collection apparatus.

### Other Embodiments

A preferred embodiment of the remnant collection apparatus proposed herein is described above. The above-described preferred embodiment is merely one example, and the present invention may be carried out in other preferred embodiments. For example, in the above-described preferred embodiment, the gap G1 of the remnant guide 40 is formed by the pair of rollers 41 and 42. Alternatively, the gap G1 of the remnant guide 40 may be a slit formed in a wall. Still alternatively, the gap G1 of the remnant guide 40 may be formed by a pair of walls located to face each other across a gap. There is no specific limitation on the member usable to form the gap G1 of the remnant guide 40. The remnant guide 40 may be, for example, located outside the cover 30 or act as an entrance to the cover 30, instead of being accommodated in the cover 40.

The structure of the adjustment device 80 is not limited to the above-described structure. For example, the adjustment device 80 may move the second roller 42, or move both of the first roller 41 and the second roller 42. The adjustment device 80 may include a member other than the ball screw 81, for example, a rack and pinion. The direction in which the first roller 41 and the second roller 42 are movable is not limited to the front-rear direction.

The absorption device 20 does not need to be located away from the cover 30 and the remnant guide 40. For example, the absorption device 20 may be directly connected with the cover 30.

The above-described preferred embodiment does not limit the present invention in any way unless otherwise specified. The technology disclosed herein may be altered in any of various manners. The elements and the processes referred to herein may each be omitted when being appropriate, or may be combined in an appropriate manner, unless any specific problem is caused.

This specification includes the following disclosure.

### Item 1

A remnant collection apparatus for an electricity storage device, the remnant collection apparatus comprising:
an absorption device absorbing a remnant generated when a band-like electrode material is cut along a longitudinal direction thereof to form an electrode sheet; and
a guide provided on a transportation route of the remnant transported by the absorption performed by the absorption device,
wherein the guide includes a gap extending in a width direction of the remnant, the remnant being insertable through the gap.

### Item 2

The remnant collection apparatus for an electricity storage device according to item 1, wherein the guide includes a pair of shafts each having a cylindrical shape extending in the width direction of the remnant, the pair of shafts forming the gap.

### Item 3

The remnant collection apparatus for an electricity storage device according to item 2, wherein the pair of shafts are each rotatable about an axis extending in the width direction of the remnant.

### Item 4

The remnant collection apparatus for an electricity storage device according to item 2 or 3, wherein:
the pair of shafts include a first shaft and a second shaft located downstream, in the transportation route of the remnant, with respect to the first shaft, and
the second shaft is located so as to overlap a tangent drawn so as to pass a point on an outer circumferential surface of the first shaft from a separation point at which the remnant is separated from the electrode sheet, and bends, together with the first shaft, the transportation route of the remnant into an S shape.

### Item 5

The remnant collection apparatus for an electricity storage device according to item 4, further comprising an adjustment device capable of causing the first shaft and the second shaft to be closer to, or to be farther from, each other.

### Item 6

The remnant collection apparatus for an electricity storage device according to any one of items 1 through 5, further comprising a tubular cover connected with the absorption device and accommodating the guide,
wherein the cover includes an observation window through which the guide is visually recognizable.

### Item 7

The remnant collection apparatus for an electricity storage device according to any one of items 1 through 6, further comprising a tubular cover connected with the absorption device and accommodating the guide,

wherein:
the cover includes a first wall and a second wall facing each other across the guide, and
the first wall and the second wall each includes an opening.

### Item 8

The remnant collection apparatus for an electricity storage device according to any one of items 1 through 7, wherein the remnant includes a narrow portion having a smaller width than that of a remaining portion thereof.

What is claimed is:

1. A remnant collection apparatus for an electricity storage device, the remnant collection apparatus comprising:
an absorption device absorbing a remnant generated when a band-like electrode material is cut along a longitudinal direction thereof to form an electrode sheet; and
a guide provided on a transportation route of the remnant transported by the absorption performed by the absorption device,
wherein the guide includes a gap extending in a width direction of the remnant, the remnant being insertable through the gap.

2. The remnant collection apparatus for an electricity storage device according to claim 1, wherein the guide includes a pair of shafts each having a cylindrical shape extending in the width direction of the remnant, the pair of shafts forming the gap.

3. The remnant collection apparatus for an electricity storage device according to claim 2, wherein the pair of shafts are each rotatable about an axis extending in the width direction of the remnant.

4. The remnant collection apparatus for an electricity storage device according to claim 2, wherein:
the pair of shafts include a first shaft and a second shaft located downstream, in the transportation route of the remnant, with respect to the first shaft, and
the second shaft is located so as to overlap a tangent drawn so as to pass a point on an outer circumferential surface of the first shaft from a separation point at which the remnant is separated from the electrode sheet, and bends, together with the first shaft, the transportation route of the remnant into an S shape.

5. The remnant collection apparatus for an electricity storage device according to claim 4, further comprising an adjustment device capable of causing the first shaft and the second shaft to be closer to, or to be farther from, each other.

6. The remnant collection apparatus for an electricity storage device according to claim 1, further comprising a tubular cover connected with the absorption device and accommodating the guide,
wherein the cover includes an observation window through which the guide is visually recognizable.

7. The remnant collection apparatus for an electricity storage device according to claim 1, further comprising a tubular cover connected with the absorption device and accommodating the guide,
wherein:
the cover includes a first wall and a second wall facing each other across the guide, and
the first wall and the second wall each includes an opening.

8. The remnant collection apparatus for an electricity storage device according to claim 1, wherein the remnant includes a narrow portion having a smaller width than that of a remaining portion thereof.
